(19) United States
(12) Patent Application Publication
(10) Pub. No.: US 2013/0080337 A1
(43) Pub. Date: Mar. 28, 2013

(54) SOCIAL NETWORKING WEB SITE WITH DINNER OFFER FEATURE

(71) Applicant: Eric Cohen, Miami, FL (US)

(72) Inventor: Eric Cohen, Miami, FL (US)

(21) Appl. No.: 13/252,734

(22) Filed: Oct. 4, 2011

Related U.S. Application Data
(63) Continuation-in-part of application No. 13/245,865, filed on Sep. 27, 2011.

(51) Int. Cl. G06Q 30/06; G06Q 30/02

(52) U.S. Cl. 705/80

(57) ABSTRACT

A method on a server for facilitating meal planning for a first and second individual over a communications network is disclosed. The method includes receiving a desired profile from the first individual over, matching the desired profile to a profile of the second individual, sending a message to the first individual indicating the match, receiving a command from the first individual including an offer to attend a meal with the second individual and an offer to pay for the meal, sending a message to the second individual including the offers, and receiving a command from the second individual accepting the offer to attend the meal and accepting the offer to pay for the meal, thereby executing a contract to attend a meal with the first individual, wherein the first individual pays for the meal.

### CROSS-REFERENCE TO RELATED APPLICATIONS

This patent application is a continuation in part of, and claims priority to, U.S. patent application Ser. No. 13/245,865 filed Sep. 27, 2011. The subject matter of U.S. patent application Ser. No. 13/245,865 is hereby incorporated by reference in its entirety.

### STATEMENT REGARDING FEDERALLY SPONSORED RESEARCH OR DEVELOPMENT

Not Applicable.

INCORPORATION BY REFERENCE OF MATERIAL SUBMITTED ON A COMPACT DISC

Not Applicable.

### FIELD OF THE INVENTION

The invention disclosed broadly relates to the field of electronic commerce, and more particularly relates to the field of social networking web sites engaging in electronic commerce.

### BACKGROUND OF THE INVENTION

Dating in modern times can be a difficult course to navigate. With the advent of internet dating, prospective suitors now have access to an increasingly larger pool of men and women to choose from. Though there are benefits to having more choices in the dating scene, there are also drawbacks. It can be more difficult, for example, to find a partner that fits a particular profile. With a larger population of people in the dating pool, it can take longer and require more effort for a person to hone in on just the right partner. This can be tedious, time-consuming and discouraging for the online dater.

Another drawback associated with the larger dating pool available in online dating is the wide variety of individuals. Because the internet has provided access to the general population, the typical online dater will encounter people of all cultures, race, ages, locations, religions, sexual orientations, socio-economic statuses and backgrounds. Since dating practices may vary among different people, however, there are adjustments that must be made when people of differing backgrounds go on a date.

For example, traditionally, the man was expected to pay when dining with a woman. In contemporary times, however, this is not always the case. Sometimes, the woman will prefer to pay for the entire meal, prefer to pay for the meal some of the time or pay half of the bill (i.e., “going Dutch”). Thus, it can be tricky and awkward to determine who should pay when the bill arrives at the end of the dining experience. This situation becomes even more complicated when same-sex couples or couples of different backgrounds are involved.

Consequently, a need exists to overcome the problems with the prior art as discussed above, and particularly for a more efficient and user-friendly way of facilitating dinner or lunch planning for two individuals.

### SUMMARY OF THE INVENTION

Briefly, according to an embodiment of the present invention, a method on a server for facilitating meal planning for a first and second individual over a communications network is disclosed. The method comprises receiving a desired profile from the first individual over the communications network; matching the desired profile to a profile of the second individual; sending a message over the communications network to the first individual indicating the profile of the second individual matched the desired profile; sending a message over the communications network to the first individual including an offer for a meal at a particular establishment; receiving a command from the first individual over the communications network, wherein the command comprises an acceptance of the offer for the meal at the particular establishment; receiving a command from the first individual over the communications network, wherein the command comprises an offer to attend a meal with the second individual at the particular establishment and an offer to pay for the meal; sending a message over the communications network to the second individual wherein the message comprises the offer from the first individual to attend a meal at the particular establishment with the second individual and the offer from the first individual to pay for the meal; and receiving a command over the communications network from the second individual accepting the offer to attend the meal at the particular establishment and accepting the offer to pay for the meal, thereby executing a contract to attend a meal with the first individual, wherein the first individual pays for the meal.

In another embodiment, a computer system for facilitating meal planning for a first and second individual over a communications network, comprising a server connected to the communications network, is disclosed. The server is configured for receiving a desired profile from the first individual over the communications network; matching the desired profile to a profile of the second individual; sending a message over the communications network to the first individual indicating the profile of the second individual matched the desired profile; sending a message over the communications network to the first individual including an offer for a meal at a particular establishment; receiving a command from the first individual over the communications network, wherein the command comprises an acceptance of the offer for the meal at the particular establishment; receiving a command from the first individual over the communications network, wherein the command comprises an offer to attend a meal at the particular establishment with the second individual and an offer to pay for the meal; sending a message over the communications network to the second individual wherein the message comprises the offer from the first individual to attend a meal at the particular establishment with the second individual and the offer from the first individual to pay for the meal; and receiving a command over the communications network from the second individual accepting the offer to attend the meal at the particular establishment and accepting the offer to pay for the meal, thereby executing a contract to attend a meal with the first individual, wherein the first individual pays for the meal.

The foregoing and other features and advantages of the present invention will be apparent from the following more particular description of the preferred embodiments of the invention, as illustrated in the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings.

FIG. 1 is a block diagram illustrating the network architecture of a system for facilitating meal planning for a first and second individual over a communications network, in accordance with one embodiment of the present invention.

FIG. 2 is a flow chart showing the control flow of the process for facilitating meal planning for a first and second individual over a communications network, according to one embodiment of the present invention.

### DETAILED DESCRIPTION

The present invention solves the problems with the prior art by providing a simple and user-friendly computer system for allowing online dating individuals to find others that match a desired profile and then make meal plans with those other individuals, wherein the subject of who pays for the meal is predetermined, thereby avoiding the awkwardness of deciding who pays for a meal. The present invention is advantageous since it allows for the online dating individuals to focus on getting to know each other and avoid wasting time and worry about awkward social protocols, such as deciding who should pay for a meal.

Additionally, the present invention improves upon the prior art by providing technologically advanced methods for advertising and promotion in an online dating environment. The present invention employs the use of push technology to push coupons and ads to users. This is advantageous as it facilitates commerce over a communications network and speeds up the process of fielding coupons and ads to a user base. Additionally, the present invention improves upon the prior art by providing the inviting individual with offers or discounts for a meal at a particular establishment. If the offer or discount is accepted, the identity of the restaurant is included in the meal invitation to the invitee, thereby enticing him or her to accept the invitation.

Many men and woman often need an extra advantage to make up for what might be something they lack—perhaps they are not good looking or to short—and thus the offer of a free meal at a fine restaurant is a way to compensate for this lack of attractiveness. By sending a “dinner do” free restaurant invitation to join them for dinner, this can even the dating field, and “dinner do” would be first site to not talk about what a member might offer as an incentive to date them, but actually offer a real offer that can be acted upon immediately as a way to make them more desirable and attractive, and raise the probability of an acceptance of a date and an actual hook-up for a relationship.

The present invention offers a method of offering a man or a woman an extra advantage to make up for what might be something they lack—perhaps they are not good looking, or they are too short—and thus they can offer a free meal at a restaurant as a way to compensate for the lack of attractiveness or social skills The “dinner do” site of the present invention is the first site to be able to have the sender offer a free meal or restaurant invitation that is adjustable by price and status, which can be used as a negotiating method of securing a dinner date. Other dating sites can only offer what might be available such as a person's looks, which may or not be real by their picture, or their car which they might or might not own, or their earnings which might or might not be true, the “dinner do” member actually presents and offers a real offer of a free meal at a mutually agreed restaurant. A real offer that can be acted upon immediately as a way to make the sending member more desirable and attractive, and thus raise the probability of an acceptance of a date with the actual end result of a dinner meeting and a potential relationship.

A unique feature of the present invention is that the dating site offers its members the ability to couple a choice of restaurants from a listing of restaurants in different ethnic menus and price venues for different economic member levels. Where the sending member as an added incentive gets a coupon incentive to choose certain restaurants based on the group buying or deal of the day coupon model. This added feature is used as a method to increase the appeal of the member and his dating offer, and thus the chance of the receiving member accepting the dinner date invitation, and thus offering the “dinner do” site a clear advantage over any other dating site which do not offer the free dinner feature.

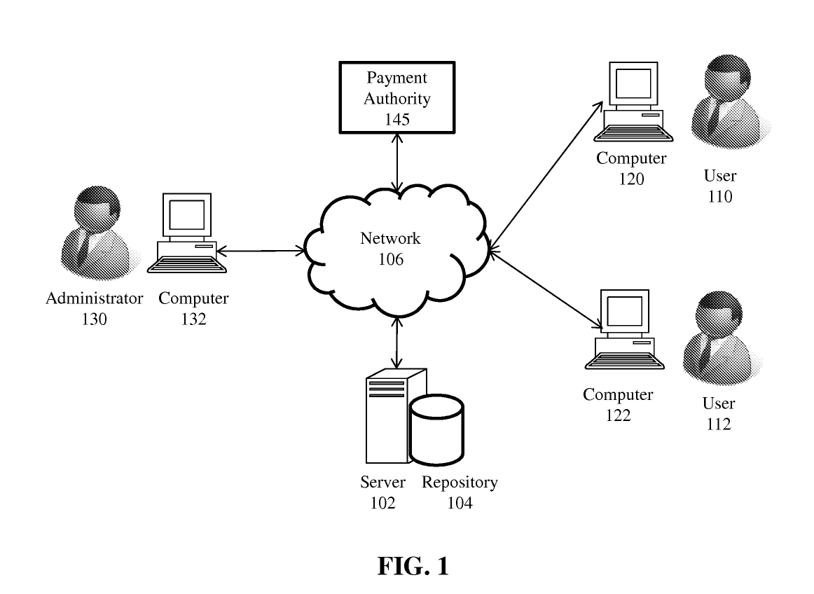

Referring now to the drawing figures in which like reference designators refer to like elements, there is shown in FIG. 1 an illustration of a block diagram showing the network architecture of a system and method for facilitating meal planning for a first and second individual over a communications network in accordance with the principles of the present invention. The most prominent element of FIG. 1 is the server 102 associated with repository or database 104 and further coupled with network 106, which can be a circuit switched network, such as the Public Service Telephone Network or a packet switched network such as the Internet or the World Wide Web. Server 102 is a central controller or operator for the functionality of the present invention, namely, a dating web site that processes and distributes data, messages, advertisements and meal offers between the users, wherein the provision of the foregoing services and data facilitates meal planning for individuals.

FIG. 1 further includes computers 120 and 122, which may be smart phones, mobile phones, tablet computers, handheld computers, laptops, desktops, or the like. Computers 120 and 122 correspond to users 110 and 112, who use the dating web site served by server 102. Computer 132 corresponds to an administrator 130, who may perform supervisory or administrative tasks on server 102. Administrator 130 may, for example, set or define advertisements or coupons for the users 110, 112. Computer 132 may be a mobile computer, a desktop computer, a common computer terminal or the like.

FIG. 1 further shows that server 102 includes a database or repository 104, which may be a relational database comprising a Structured Query Language (SQL) database stored in a SQL server. Client computers 120, 122 and 132 may also each include their own database. The repository 104 serves data from a database, which is a repository for data used by server 102 and the client computers during the course of operation of the invention.

The database 104 may include a user record for each user 110 and 112. A user record may include: contact/identifying information for the user (such as age, sex, location, socioeconomic status, height, weight, hair color, eye color, skin color, race, nationality, address, social security number, address, yearly income, religion, sexual orientation, etc.), electronic payment information for the user, information pertaining to messages or meal offers sent by the user, information pertaining to the purchases or coupons redeemed by the user, etc. In one alternative, a user record may include restaurant or meal location preferences, and date and time preferences for meals. In one embodiment, electronic payment information may comprise buyer contact/identifying information, credit card data garnered from a credit or debit card and authentication information. A user's record may be searched or viewed by others in the form of a user profile, commonly used in well-known social networking sites, that displays certain information to others.

FIG. 1 shows an embodiment of the present invention wherein networked computing devices 120, 122 and 132 interact with server 102 and repository 104 over the network 106. Server 102 includes a software engine that delivers applications, data, program code and other information to networked computing devices 120, 122 and 132. The software engine of server 102 may perform other processes such as audio and/or video streaming or other standards for transferring multimedia data in a stream of packets that are interpreted and rendered by a software application as the packets arrive. It should be noted that although FIG. 1 shows only three networked computing devices 120, 122 and 132, the system of the present invention supports any number of networked computing devices connected via network 106.

In one embodiment of the present invention, the application provided by the server 102 of FIG. 1 is a client-server application having a client portion that resides on a client computer (i.e., 120, 122 and 132) and a server application that resides on server 102. For example, the application can be a web interface that is accessed by a client computer via network 106. The application served by server 102 may be written using any of the following technologies: CSS (Cascading Style Sheets), DOM (Document Object Model), JavaScript, XPCOM (Cross-Platform Component Object Model), XPConnect, XPI (Cross-Platform Installer), XUL (XML User Interface Language).

Server 102 may include program logic comprising computer source code, scripting language code or interpreted language code that is compiled to produce computer instructions that perform various functions of the present invention. In one embodiment of the present invention, the program logic is a scripting language such as ECMAScript, CSS, XML (Extensible Markup Language), XSLT (Extensible Style-sheet Language Transformations), Javascript, AJAX (Asynchronous JavaScript and XML), XUL, JSP, PHP, and ASP (Active Server Pages). The program logic may reside on a client computer (such as 120, 122, or 132), the server 102 or any combination of the two.

Note that although server 102 is shown as a single and independent entity, in one embodiment of the present invention, the functions of server 102 may be integrated with another entity, such as one of the client computers or payment authority 145. Further, server 102 and its functionality, according to a preferred embodiment of the present invention, can be realized in a centralized fashion in one computer system, or in a distributed fashion where different elements are spread across several interconnected computer systems.

The network architecture of FIG. 1 in accordance with the principles of the present invention may give rise to various revenue-generating arrangements. The administrator 130 may distribute advertisements or coupons to users 110, 112 in exchange for a fee paid to the operators of server 102. The users 110, 112 may also, for example, pay an ongoing or per-transaction fee to the operators of server 102 in exchange for the services provided by server 102.

FIG. 1 also shows a payment authority 145 to effectuate payments by users 110 or 112 for coupons, services or the like. In the course of a sales transaction, the program logic of server 102 may interface with payment authority 145 to effectuate payment. In one embodiment of the present invention, the payment authority 145 is a payment gateway, which is an e-commerce Application Service Provider (ASP) service that authorizes payments for individuals, e-businesses, online retailers, or traditional brick and mortar businesses. The payment authority 145 may accept payment via the use of credit cards, charge cards, bank cards, gift cards, account cards, etc.

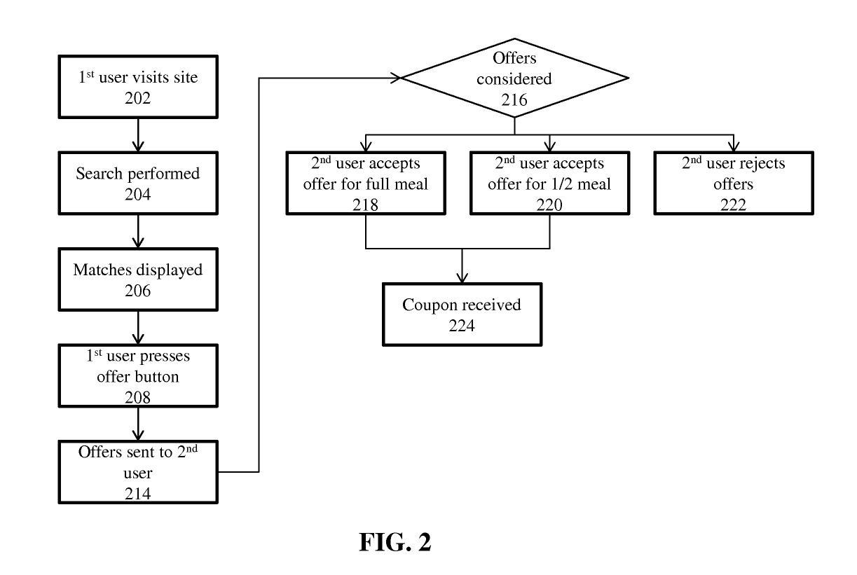

FIG. 2 is a flow chart showing the control flow of the process for facilitating meal planning for a first and second individual over a communications network, according to one embodiment of the present invention.

In step 202, the first individual 110 may visit the web site of server 102, using a web browser, for example, and enters a desired profile or desired search parameters that represent the type of person or partner user 110 is seeking. The desired profile or search parameters may include any information that is normally found in a user's record or profile, such as age, sex, location, etc. In step 204, the server 102 takes the desired profile or desired search parameters entered by the user 110 and searches the profiles or user records in database 104 for matching profiles or records. In step 206, the server 102 displays the matching profiles or records in the web browser of user 110. Subsequently, the user 110 may view the matching profiles or records in the web browser. In one alternative, an offer or discount (previously defined by an administrator, as described below) for a meal at a particular establishment is sent to the user 110 and viewed in a graphical user interface. The offer or discount may be targeted according to data in the profile of user 110, as defined below. In this alternative, the user 110 accepts the offer or discount by interacting with the interface and thereby sends a message to the server 102 accepting the offer.

In step 208, the user 110 identifies the profile of a user, user 112 to be exact, deemed to be an appropriate partner, and the user 110 presses a button or clicks a link in the web browser that sends a command to the server 102 to send a message to the user 112 comprising an offer from user 110 to attend a meal with the user 112 and an offer to pay for all or half of the meal. In one embodiment, the user 110 may have previously selected a location or restaurant for dinner and this location or restaurant is attached to his offer to user 112. In another embodiment, the user 110 may select suggested dates and times for dinner and this data is attached to his offer to user 112.

In step 214, server 102 sends a message the user 112 comprising an offer from user 110 to attend a meal with the user 112 and an offer to pay for all or half of the meal. In one embodiment, the location or restaurant selected by user 110, as well as any proposed dates and times, is sent to user 112 in the message of step 214.

In step 216, the user 112 views the message, such as in a web browser, and determines his or her response. In step 218, the user 112 sends an acceptance of the offer to attend a meal and pay for the meal (such as by clicking on a link or pressing a button in the web browser), thereby executing a contract to attend a meal with user 110, wherein user 110 pays for the meal. In step 220, the user 112 sends an acceptance of the offer to attend a meal and pay for half of the meal (i.e., “going Dutch”), thereby executing a contract to attend a meal with user 110, wherein each user pays for half of the meal. In steps 218, 220, the user 112 may also accept the time/date and/or location of the restaurant or establishment for the meal. In step 222, the user 112 sends a rejection of the offers from user 110. In one alternative, the user 112 may send a rejection to user 110 but may also send a suggestion for another location or restaurant, thereby indicating that user 112 may change his or her mind if user 110 makes another offer with the suggested location or restaurant.

In step 224, one or both of the users 110, 112 receive an offer, discount, advertisement, a group buying offer, a regular coupon or a for-pay coupon in an electronic message, wherein the ad or coupon is directed to a restaurant or other food-related business where the users 110, 112 may enjoy the meal they have just contracted to undertake. The users may purchase the coupon by interfacing with the payment authority 145. In one embodiment, the ad or coupon may be targeted as specified below.

In one embodiment of the present invention, administrator 130 may interface with computer 132 (or server 102 directly) to generate an offer, discount, advertisement, coupon, for-pay coupon, group-buying coupon or promotion (hereinafter referred to as a “coupon” or “offer”) and the server 102 disseminates it to users 110, 112 via push technology. Push technology, or server push, describes a style of Internet-based communication where the coupon, created by administrator 130, is transmitted by the server 102 to clients. Push technology is contrasted with pull technology, where the request for the transmission of information is initiated by the receiver or client. Examples of push technology include HTTP server push, a pushlet, long polling and Flash XMLSocket relays.

In this embodiment, administrator 130 generates a coupon definition and sends it to the server 102. The coupon definition may include a description of goods/services being promoted, a percentage discount on goods, a price for goods, a rebate on goods, still images, video, audio, a time limit for the promotion or sale, a tipping point for the group buying offer to trigger, or the like. The coupon definition may also include data pertaining to the target for the coupon, such as a location, a region, a time period, or demographic data describing individuals to which the offer is directed, including any such data that is kept in the user records or profiles. The coupon definition is then provided to server 102, wherein the server 102 processes the coupon definition and determines how to implement it. For example, the server 102 may determine to whom the corresponding coupon is transmitted, based on the target data specified in the coupon definition. Once processed, the server 102 transmits the corresponding coupon to the intended recipients, such as users 110 and 112, via push technology at the specified time. Specifically, server 102 transmits the offer to the computers 120 and 122 of the users 110 and 112, respectively.

The present invention can be realized in hardware, software, or a combination of hardware and software in the system described in the figures above. A system according to a preferred embodiment of the present invention can be realized in a centralized fashion in one computer system or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

An embodiment of the present invention can also be embedded in a computer program product, which comprises all the features enabling the implementation of the methods described herein, and which—when loaded in a computer system—is able to carry out these methods. Computer program means or computer program as used in the present invention indicates any expression, in any language, code or notation, of a set of instructions intended to cause a system having an information processing capability to perform a particular function either directly or after either or both of the following a) conversion to another language, code or, notation; and b) reproduction in a different material form.

A computer system may include, inter alia, one or more computers and at least a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits. The computer readable medium does not include computer readable information in a transitory state medium.

In this document, the terms “computer program medium,” “computer usable medium,” and “computer readable medium” are used to generally refer to media such as main memory removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as Floppy, ROM, Flash memory, Disk drive memory, CD-ROM, and other permanent storage. It is useful, for example, for transporting information, such as data and computer instructions, between computer systems.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

We claim:

1. A method on a server for facilitating meal planning for a first and second individual over a communications network, comprising:
receiving a desired profile from the first individual over the communications network;
matching the desired profile to a profile of the second individual;
sending a message over the communications network to the first individual indicating the profile of the second individual matched the desired profile;
sending a message over the communications network to the first individual including an offer for a meal at a particular establishment;
receiving a command from the first individual over the communications network, wherein the command comprises an acceptance of the offer for the meal at the particular establishment;
receiving a command from the first individual over the communications network, wherein the command comprises an offer to attend a meal with the second individual at the particular establishment and an offer to pay for the meal;
sending a message over the communications network to the second individual wherein the message comprises the offer from the first individual to attend a meal at the particular establishment with the second individual and the offer from the first individual to pay for the meal; and
receiving a command over the communications network from the second individual accepting the offer to attend the meal at the particular establishment and accepting the offer to pay for the meal, thereby executing a contract to attend a meal with the first individual, wherein the first individual pays for the meal.

2. The method of claim 1, wherein the desired profile includes one or more of: an age, a sex, a race, a location, a height, a weight, a socio-economic status indicator, a religion and a sexual orientation.

3. The method of claim 2, wherein the profile of the second individual includes one or more of: an age, a sex, a race, a location, a height, a weight, a socio-economic status indicator, a religion and a sexual orientation.

4. The method of claim 3, wherein a message comprises an email, a text, or a textual message displayed in a computer interface.

5. The method of claim 4, wherein a command comprises a message sent to the server via a graphical user interface with at least one button that an individual presses.

6. The method of claim 1, wherein a meal consists of any one of breakfast, lunch or dinner.

7. The method of claim 1, sending a targeted advertisement to at least one of the first and the second individual based on the contract.

8. A method on a server for facilitating meal planning for a first and second individual over a communications network, comprising:
receiving a desired profile from the first individual over the communications network;
matching the desired profile to a profile of the second individual;
sending a message over the communications network to the first individual indicating the profile of the second individual matched the desired profile;
sending a message over the communications network to the first individual including an offer for a meal at a particular establishment;
receiving a command from the first individual over the communications network, wherein the command comprises an acceptance of the offer for the meal at the particular establishment;
receiving a command over the communications network from the first individual, wherein the command comprises an offer to attend a meal with the second individual at the particular establishment and an offer to pay for all or half of the meal;
sending a message over the communications network to the second individual wherein the message comprises the offer from the first individual to attend a meal at the particular establishment with the second individual and the offer from the first individual to pay for all or half of the meal; and
receiving a command over the communications network from the second individual, the command: 1) accepting the offer to attend the meal at the particular establishment, 2) accepting the offer to pay for half of the meal, and 3) and agreeing to pay for half of the meal, thereby executing a contract to attend a meal with the first individual, wherein each individual will pay for half of the meal.

9. The method of claim 8, wherein the desired profile includes one or more of: an age, a sex, a race, a location, a height, a weight, a socio-economic status indicator, a religion and a sexual orientation.

10. The method of claim 9, wherein the profile of the second individual includes one or more of: an age, a sex, a race, a location, a height, a weight, a socio-economic status indicator, a religion and a sexual orientation.

11. The method of claim 10, wherein a message comprises an email, a text, or a textual message displayed in a computer interface.

12. The method of claim 11, wherein a command comprises a message sent to the server via a graphical user interface with at least one button that an individual presses.

13. The method of claim 8, wherein a meal consists of any one of breakfast, lunch or dinner.

14. The method of claim 8, sending a targeted advertisement to at least one of the first and the second individual based on the contract.

15. A computer system for facilitating meal planning for a first and second individual over a communications network, comprising a server connected to the communications network, wherein the server is configured for:
receiving a desired profile from the first individual over the communications network;
matching the desired profile to a profile of the second individual;
sending a message over the communications network to the first individual indicating the profile of the second individual matched the desired profile;
sending a message over the communications network to the first individual including an offer for a meal at a particular establishment;
receiving a command from the first individual over the communications network, wherein the command comprises an acceptance of the offer for the meal at the particular establishment;
receiving a command from the first individual over the communications network, wherein the command comprises an offer to attend a meal at the particular establishment with the second individual and an offer to pay for the meal;
sending a message over the communications network to the second individual wherein the message comprises the offer from the first individual to attend a meal at the particular establishment with the second individual and the offer from the first individual to pay for the meal; and
receiving a command over the communications network from the second individual accepting the offer to attend the meal at the particular establishment and accepting the offer to pay for the meal, thereby executing a contract to attend a meal with the first individual, wherein the first individual pays for the meal.

16. The computer system of claim 15, wherein the desired profile includes one or more of: an age, a sex, a race, a location, a height, a weight, a socio-economic status indicator, a religion and a sexual orientation.

17. The computer system of claim 16, wherein the profile of the second individual includes one or more of: an age, a sex, a race, a location, a height, a weight, a socio-economic status indicator, a religion and a sexual orientation.

18. The computer system of claim 17, wherein a message comprises an email, a text, or a textual message displayed in a computer interface.

19. The computer system of claim 18, wherein a command comprises a message sent to the server via a graphical user interface with at least one button that an individual presses.

20. The computer system of claim 15, wherein the server is further configured for sending a targeted advertisement to at least one of the first and the second individual based on the contract.
